(19) United States
(12) Patent Application Publication
(10) Pub. No.: US 2006/0229179 A1
(43) Pub. Date: Oct. 12, 2006

(54) Base insert device for paper bags

(76) Inventors: Marco Daher, Wallenhorst (DE); Uwe Koehn, Osnabrueck (DE); Andreas Lamkemeyer, Osnabrueck (DE)

Correspondence Address: JACOBSON HOLMAN PLLC, 400 SEVENTH STREET N.W., SUITE 600, WASHINGTON, DC, 20004, US

(21) Appl. No.: 10/563,860

(22) PCT Filed: Jul. 5, 2004
(86) PCT No.: PCT/EP04/07298

§ 371 Date: Jan. 9, 2006

(30) Foreign Application Priority Data
Jul. 7, 2003 (DE) 103 30 750.8

(51) Int. Cl. B31C 11/04

(52) U.S. Cl. 493/276

(57) ABSTRACT

The present invention relates to a base insert device for crossed base valve bags for the formation of crossed bases in paper bags, by means of folding devices which introduce folds at the ends of the tubular sections from which the bags are produced, with one or more gluing stations, which apply glue to the regions of the folds for gluing and/or the sheets (5) provided for gluing to the base, in the gluing stations and at least one pressing station in which the folded bases and the sheets (5) are brought into contact and glued. The novelty of the present patent application is that at least one gluing station for the sheets and/or bases is provided, comprising glue outlet openings (22) which may be selectively supplied with glue, whereby the selection of the glue outlet openings (22) defines the format of the glue application (6, 7, 8, 9). Said glue outlet openings (22) are provided with at least two application heads (1) of which at least one application head (1) may be displaced in a direction (y) orthogonal to the feed direction of the sheets (5) and/or the folded bases such that as a result of the displacement, a relative movement of the two application heads (1) occurs.

This is a nationalization of PCT/EP04/007298 filed Jul. 5, 2004 and published in German.

The present invention relates to a base insert device for paper bags in accordance with the preamble of main claim 1.

Devices of this type are used in the production of various types of bags. These bags include, for example, the so-called valve bags in which valve patches are usually inserted when manufacturing the bases of the bags. The bases are frequently designed as crossed bases as illustrated, for example in the patent applications DE 090 145 48 U1 and DE 3020043 A1. In order to provide the bases and the inserted valve patches with a lasting cohesion, parts of the bases are stuck one below the other and/or to the valve patches with the help of glue.

For this purpose, glue is applied to either the regions of the base folds to be glued or the sheets provided to them, thus all the regions that are to be glued to one another and these are subsequently glued to one another by merging them or folding them together.

A format-specific glue application usually takes place in the following manner: A format part attached on a rotating roller is brought into contact during the rotation of said roller with a glue roller or with other glue storing components or transfer components and is thus supplied with glue. In the further course of the rotation of the roller, the format plate transfers the glue stored on it onto each region of the subsequently formed bases of the bags or the sheets to be glued. For this purpose, the format part is provided with characteristic ridges that are adapted to a definite bag format. The format parts are replaced for producing bags having other formats on the base insert device. This type of glue application has stood the test of time since it enables the clean and format-specific application of large quantities of the starch glue, which is otherwise difficult to handle.

The words “format-specific glue application” refers toga form of application that is adapted to the type and the format of the bag. In this form of application, the glue is usually applied in a flat manner, whereby special significance is accorded to the edges of the form for the durability and the impermeability of the bags.

However, the disadvantage is that this method of glue transfer makes it necessary to provide and subsequently clean a plurality of glue transfer components, for instance the format rollers and the format parts.

Therefore the object of the present invention is to further improve the design of the base insert device in such a way that these glue transfer components can be totally omitted or at least reduced in number while still enabling a format-specific glue application.

The present invention is based on the well-known base insert devices, which exclusively comprise gluing stations that require format parts for defining the format of the glue application.

The above-mentioned object is achieved by a base insert device comprising at least one gluing station for sheets and/or bases
that comprises glue outlet openings, which may be selectively supplied with glue, whereby the selection of the glue outlet openings defines the format of the glue application,
whereby said glue outlet openings are provided with at least two application heads
of which at least one application head may be displaced in a direction orthogonal to the feed direction of the sheets and/or the folded bases, such that, as a result of the displacement, a relative movement of the two application heads occurs.

The first subsection of the characterizing part deals with the definition of the glue application by extruding glue from glue outlet nozzles that can be selectively supplied with glue. By opening and closing glue valves, it is possible to determine which glue outlet openings are to be supplied with glue and which are not. The manner in which the glue profile is formed is described in the unpublished patent application DE 103 09 893. However, unlike the patent application mentioned above, the present invention also comprises devices, which do not extrude the glue directly onto the bag components. Rather these devices first provide the glue profile to another machine component such as a roller and then transfer it onto the bag components.

The afore-mentioned valves are usually connected to one or more glue supplying lines or glue reservoirs in which the glue is exposed to pressure.

Application heads as set forth in the present invention are machine components, which are provided with glue outlet openings. These application heads usually contain a plurality of openings, are provided with glue supplying lines and also support a large number of valves. If a gluing station has only one application head, then the distance of the glue outlet openings in the direction perpendicular to the feed direction of the sheets or the tubular sections is decisive for the precision with which random glue profiles can be reproduced. However, due to the above-mentioned functions of an application head, this distance cannot be reduced randomly. If two or more application heads are provided whose relative positions in the direction perpendicular to the feed direction of the sheets or the tubular sections can be changed, then the possibility of the format-specific glue application improves considerably. In this connection, it is particularly important to supply the edges of the sheets and/or regions of the bases of the bags to be glued with sufficient quantities of glue.

It is advantageous to provide every application head with an application plate in which several glue outlet openings are arranged equidistantly in each case on one line in the direction perpendicular to the feed direction of the sheets and/or the folds of the bases. The application plates are arranged in such a way that the adjoining glue outlet openings of two different application heads can take up a distance that is smaller than the described equidistant distance. This is feasible if the application plates are arranged on the application heads such that they can be displaced easily. For example, in case of three application heads, the application plate can be attached centrally to the middle application head, whereas the application plates can be attached to the outer application heads in such a way that they can easily move towards the middle application head. In this manner it is possible that when the outer application heads are moved outwards, there is no large distance between the glue outlet openings at the borders of the adjoining application heads and thus between the subsequently formed glue traces. An excessively large distance could result in an insufficient glue application.

In a preferred embodiment of the present invention, means are provided for automatically displacing at least one application head and also a control unit, which controls the displacement. In this manner it is possible to prevent a manual displacement of the application heads, due to which the described gluing stations can be built with a more compact design.

It is advantageous if the target image of the glue application is supplied to the control unit and if the control unit has means to calculate the target positions of the glue traces to be extruded from the glue outlet openings based on this target image. The target image can be supplied externally to the control unit, for example by manual entry or from a memory that can contain a large number of such target images. The control unit can control the displacement of the application heads based on the target positions of the glue traces on the sheet and/or of the base region to be glued where said target positions are calculated based on the target image.

It is advantageous to provide position sensors, which record the actual position at least of one spindle and notify the control unit. With the actual position of the spindle, simultaneously the actual position of the application heads, thus their relative position to the machine components transporting the sheets or the bases also becomes known. By comparing the target position and actual position of the application heads, it is possible to ensure an error-free positioning of the application heads.

In another embodiment of the present invention, a common glue supplying line is provided from which all the application heads of the gluing station are supplied with glue. A common glue supplying line as set forth in the present invention means that all application heads are supplied with glue from this line. However the glue supply unit can be located at any point of the glue supplying line so that the glue flow splits at the supply point, but from the supply point, the glue is supplied to the application heads serially. The glue supplying line preferably runs essentially in a direction orthogonal to the feed direction of the sheets so that all valves are supplied with glue as directly as possible.

It is particularly preferable if the glue supplying line is designed as a guide rail. For this purpose, the glue supplying line can be designed as a tube, which has boreholes in the region of the application heads so that the glue can be discharged there.

An advantageous embodiment of the present invention comprises guide elements, which guide the bag components to be glued in the region of the gluing station. The guide elements can be displaced together with the displaceable application head. In this manner it is ensured that the bag components take up a defined position relative to the application heads during the gluing process. Thus, for example it is possible to ensure that the bag components are firmly pressed onto the rollers conveying them.

Additional advantageous embodiments of the present invention are specified in the graphic description, the drawings and the remaining claims. The individual figures illustrate:

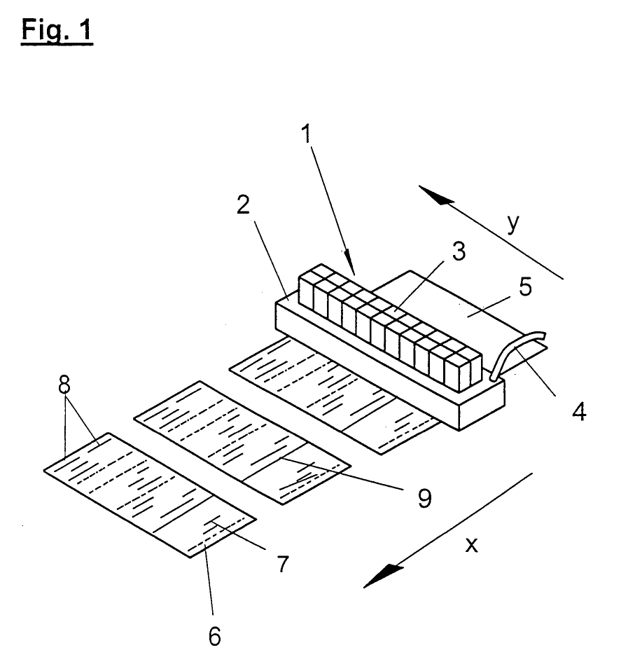

FIG. 1 an individual application head provided for the gluing station in the base insert device according to the present invention

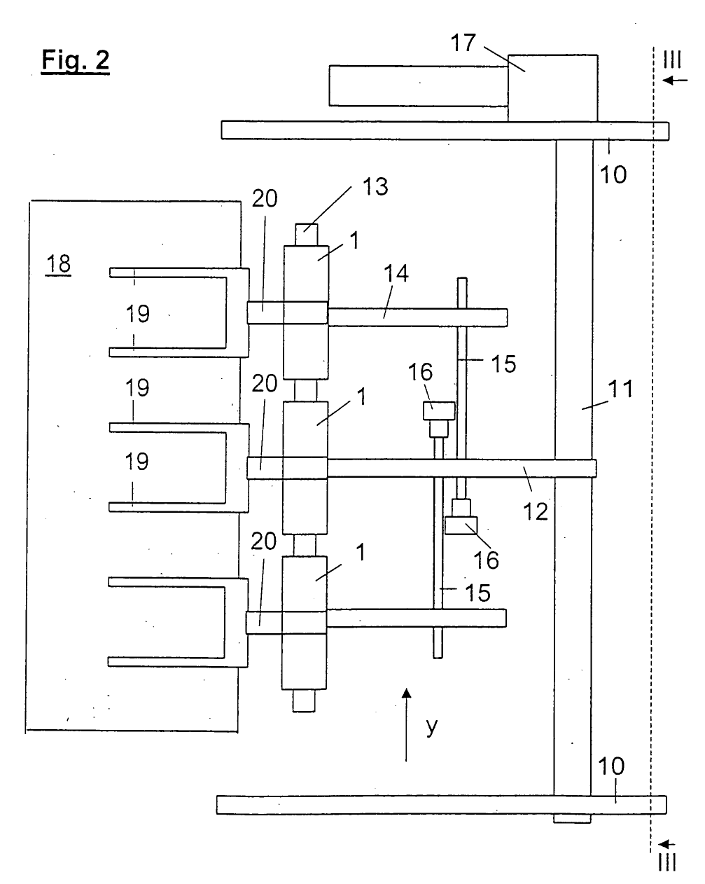

FIG. 2 an overview of the gluing station in the base insert device according to the present invention

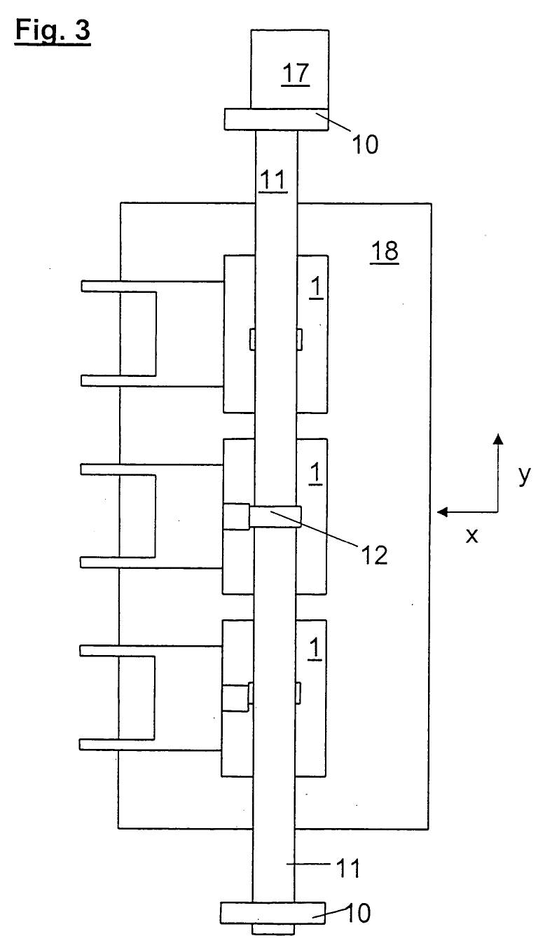

FIG. 3 view III-III illustrated in FIG. 2

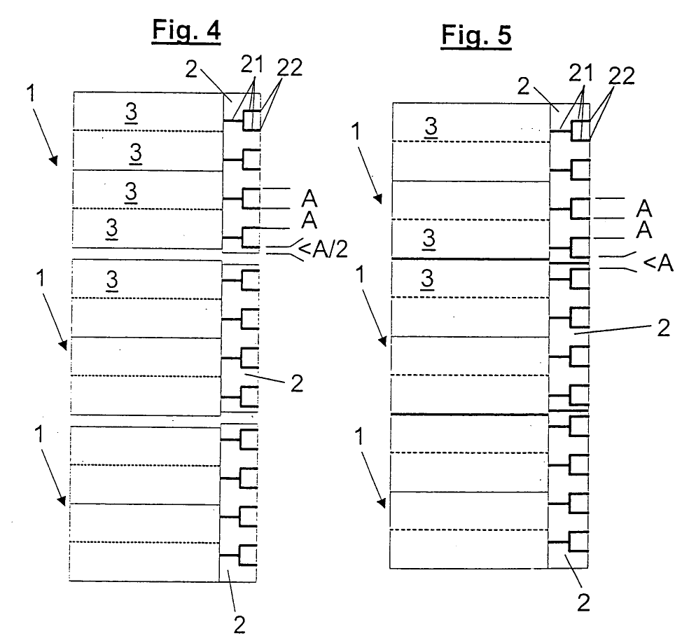

FIG. 4 schematic illustration of the application heads illustrated in FIGS. 2 and 3 in a position in which they are pulled apart from one another

FIG. 5 schematic illustration of the three application heads illustrated in FIG. 4, however, in a position in which they travel together.

FIG. 1 illustrates an application head 1, as is used in a gluing station in the base insert device according to the present invention. This application head 1 is composed of an application plate 2, to which valves 3 are attached. The glue is supplied to the application head 1 via the glue supplying line 4. Unglued sheets 5 are supplied to the gluing station in direction x.

Every valve 3 is provided with one glue outlet opening or a group of glue outlet openings in the side of the application plate 2 that is turned towards the unglued sheets 5. The glue flow to the glue outlet opening can be produced or interrupted by the assigned valve 3. In this manner it is possible to apply on the unglued sheet 5 different glue traces that run parallel to the feed direction x of the unglued sheets 5. By regularly opening and closing the valve 3, a regularly interrupted glue trace 5 [sic: 6] can be applied. Likewise, it is possible to produce short glue traces 7 or interrupted glue traces 8 and continuous glue traces 9. If no unglued sheet 5 is located below the application head 1, then all the valves 3 interrupt the glue flow so that the gluing station is not contaminated unnecessarily. In order to be able to glue all the regions of the unglued sheets in the direction y perpendicular to the feed direction, the application head 1 can also be displaced in this direction. However, the application head 1 just described above can be used not only for gluing sheets 5, but also is suitable for applying glue on the regions of the subsequently formed bases of the bags to be glued due to the variability of the glue traces that can be produced.

FIGS. 2 and 3 illustrate a gluing station in a base insert device according to the present invention in which three application heads 1 are provided. Both the outer application heads 1 can be supported on a guide rail 13 in such a way that they can be displaced in direction y. The middle application head 1 can be permanently connected to the guide rail 13. The guide rail 13 is attached using the supporting arm 12 to the rod 11, which in turn is supported in both the parts of the frame 10 such that it can be displaced in direction y. The rod 11 and with it the middle application head 1 are displaced by activating the drive 17, which can be a step motor, for example. Holders 14 are permanently attached to the outer application heads 1. The holders 14 contain threaded boreholes, which serve as spindle nuts and into which spindles 15 are screwed. The spindles 15 are supported in the supporting arm 12 in such a way that they are rotatable, though not displaceable. The spindles 15 are driven using drive units 16, which are connected to the supporting arm 12 in a manner that is not illustrated in detail. In this gluing station, the external application heads 1 can be moved independently of one another in such a way that, when seen in direction y, the outer edges of the sheets (not illustrated in these figures) can also be provided with glue. The sheets run on the roller 18 in the direction x (indicated in FIG. 3) and are held on this roller 18 by the guide elements 19. The guide elements 19 are connected using the holders 20 to the application heads 1 so that the guide elements 19 are also displaced along with the displacement of the application heads 1.

FIGS. 4 and 5 schematically illustrate the three application heads 1 illustrated in FIGS. 2 and 3. Of the application heads I, essentially the valves 3 can be seen, which are arranged on the application head 1 with practically no interspaces. Every valve 3 can deliver glue into the glue distribution channels 21 that are inserted into the application plate 2. The glue distribution channels 21 distribute the glue on two glue outlet openings 22. Naturally even a smaller or a larger number of glue outlet openings 22 can be provided, whereby however the glue discharge can be produced or interrupted simultaneously for all the glue outlet openings 22 assigned to a valve 3. The glue outlet openings 22 are arranged in such a way that they take up an equidistant distance A from one another.

The edges of the application plates 2 are trimmed down in such a way that the distance between these edges and the respective first glue outlet opening 22 is smaller than half the distance A. In addition, the application plates 2 of both the outer application heads 1 are attached in such a way that they can be easily displaced towards the middle application head 1. In this manner, in the position in which the application heads travel together, the distance between two adjoining glue outlet openings 22 that belong to two different application plates 2 is smaller than the distance A between the glue outlet openings 22 on an application plate 2. This situation is illustrated in FIG. 5. Using the illustrated embodiment, it is possible to move the application heads 1 apart from one another over a large adjustable range without requiring the adjoining glue outlet openings 22 belonging to two different application plates 2 to take up a larger distance than the distance A. Naturally it is also possible to move the application heads so far that the adjoining glue outlet openings 22 take up a larger distance than the distance A.

List of Reference Symbols

| | |
|---|---|
| 1 | Application head |
| 2 | Application plate |
| 3 | Valve |
| 4 | Glue supplying line |
| 5 | Unglued sheet |
| 6 | Regularly interrupted glue trace |
| 7 | Short glue trace |
| 8 | Interrupted glue trace |
| 9 | Continuous glue trace |
| 10 | Frame |
| 11 | Rod |
| 12 | Supporting arm |
| 13 | Guide rail |
| 14 | Holder |
| 15 | Spindle |
| 16 | Drive unit |
| 17 | Drive |
| 18 | Roller |
| 19 | Guide element |
| 20 | Support |
| 21 | Glue distribution channels |
| 22 | Glue outlet opening |
| A | Distance between two glue outlet openings 22 |
| x | Feed direction of the sheets |
| y | Direction perpendicular to the feed direction x of the sheets |

1. Base insert device for crossed base valve bags, for the formation of crossed bases in paper bags, said device comprising the following characteristics:
Folding devices which introduce folds at the ends of the tubular sections from which the bags are produced
One or more gluing stations, which apply glue to the regions of the folds for gluing and/or the sheets (5) provided for gluing to the bases in the gluing stations
At least one pressing station in which the folded bases and the sheets (5) are brought into contact and glued
Said device is characterized by
at least one gluing station for the sheets and/or bases
that comprises glue outlet openings (22) which may be selectively supplied with glue, whereby the selection of the glue outlet openings (22) defines the format of the glue application (6, 7, 8, 9),
whereby said glue outlet openings (22) are provided with at least two application heads (1)
of which at least one application head (1) may be displaced in a direction (y) orthogonal to the feed direction of the sheets (5) and/or the folded bases such that as a result of the displacement, a relative movement of the two application heads (1) occurs.

2. Base insert device pursuant to claim 1 characterized in that in the gluing station every application head (1) is provided with an application plate (2) in which several glue outlet openings (22) are each arranged equidistantly at a distance (A) on one line in the direction (y) perpendicular to the feed direction of the sheets (5) and/or the folds of the bases, whereby the application plates (2) are arranged in such a way that the adjoining glue outlet openings (22) of two different application heads (1) can take up a different distance than the distance (A).

3. Base insert device pursuant to claim 1 characterized in that in the gluing station, the two application heads (1) are displaceably supported on a common guide rail (13).

4. Base insert device pursuant to claim 1 characterized by at least one spindle drive (15, 16) for providing the force for moving at least one displaceable application head (1).

5. Base insert device pursuant to claim 4 characterized in that the spindle (15) can be driven using a motor.

6. Base insert device pursuant to claim 1 characterized by means for automatically displacing the application head (1) and a control unit that controls the displacement.

7. Base insert device pursuant to claim 6 characterized in that the target image of the glue application (6, 7, 8, 9) can be supplied to the control unit and that the control unit comprises means to calculate the target positions of the glue traces (6, 7, 8, 9) to be extruded from the glue outlet openings based on the target image.

8. Base insert device pursuant to claim 6 characterized by position sensors, which record the actual position of a spindle (15) and/or the rod (11) and notify the control unit.

9. Base insert device pursuant to claim 1 characterized in that all the application heads (1) of the gluing station can be supplied with glue from one common glue supplying line, which guides the glue directly towards the application heads.

10. Base insert device pursuant to claim 9 characterized in that the glue supplying line runs essentially in a direction (y) orthogonal to the feed direction of the sheets (5) and/or of the bases of the bags.

11. Base insert device pursuant to claim 9 characterized in that the glue supplying line is designed as a guide rail (13).

12. Base insert device pursuant to claim 1 characterized by guide elements (19) which guide the bag components to be glued in the region of the gluing station, whereby the guide elements (19) can be displaced together with the displaceable application head (1).

13. Method for operating a base insert device pursuant to claim 1 characterized in that in the gluing station, one application head (1) remains stationary with respect to the guide rail (13) during the format adjustment.

14. Process pursuant to claim 13 characterized in that the format is defined by three application heads (1) of which the middle one remains stationary with respect to the guide rail (13) during the adjustment of the format.
